(19) United States
(12) Patent Application Publication
(10) Pub. No.: US 2022/0184438 A1
(43) Pub. Date: Jun. 16, 2022

(54) Remotely Controlled Fire Suppression Assembly

(71) Applicant: Joshua Smith, Sacramento, CA (US)

(72) Inventor: Joshua Smith, Sacramento, CA (US)

(21) Appl. No.: 17/123,994

(22) Filed: Dec. 16, 2020

(51) Int. Cl. A62C 37/40; A62C 3/02

(52) U.S. Cl. CPC A62C 37/40; A62C 3/0292

(57) ABSTRACT

A remotely controlled fire suppression assembly includes a water reservoir that is positioned adjacent to a building and a fire retardant reservoir that is positioned adjacent to the building. A pumping unit is positioned adjacent to the building and the pumping unit is in fluid communication with each of the water reservoir and the fire retardant reservoir. A fire sensor is coupled to the building and the fire sensor turnings on the pumping unit when the fire sensor senses heat and moisture that correspond to conditions of an active fire. A plurality of sprinklers is provided and each of the sprinklers is in fluid communication with the pumping unit. The plurality of sprinkler is distributed on and around the building to spray the mixture of water and fire retardant for extinguishing a fire on or around the building.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fire suppression devices and more particularly pertains to a new fire suppression device for extinguishing a fire in or around a building. The fire suppression device includes roof mounted sprinklers, eave mounted sprinklers and ground mounted sprinklers. Additionally, the fire suppression device includes a propane fueled generator for supplying electrical energy for the fire suppression device.

### (2) Description of Related Art including information disclosed under 37 CFR 1.97 and 1.98

The prior art relates to fire suppression devices including a preemptive fire suppression system that detects a fire approaching a building and subsequently extinguishes the approaching fire. The prior art discloses a variety of fire sprinkler systems that include roof mounted sprinklers and eave mounted sprinklers for extinguishing a fire that is approaching a building. The prior art also discloses a remotely controlled fire sprinkler system in a building.

### BRIEF SUMMARY OF THE INVENTION

An embodiment of the disclosure meets the needs presented above by generally comprising a water reservoir that is positioned adjacent to a building and a fire retardant reservoir that is positioned adjacent to the building. A pumping unit is positioned adjacent to the building and the pumping unit is in fluid communication with each of the water reservoir and the fire retardant reservoir. A fire sensor is coupled to the building and the fire sensor turnings on the pumping unit when the fire sensor senses heat and moisture that correspond to conditions of an active fire. A plurality of sprinklers is provided and each of the sprinklers is in fluid communication with the pumping unit. The plurality of sprinkler is distributed on and around the building to spray the mixture of water and fire retardant for extinguishing a fire on or around the building.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective in-use view of a remotely controlled fire suppression assembly according to an embodiment of the disclosure.

FIG. 2 is a schematic view of an embodiment of the disclosure.

FIG. 3 is a top perspective view of an embodiment of the disclosure.

FIG. 4 is a perspective in-use view of an embodiment of the disclosure.

### DETAILED DESCRIPTION OF THE INVENTION

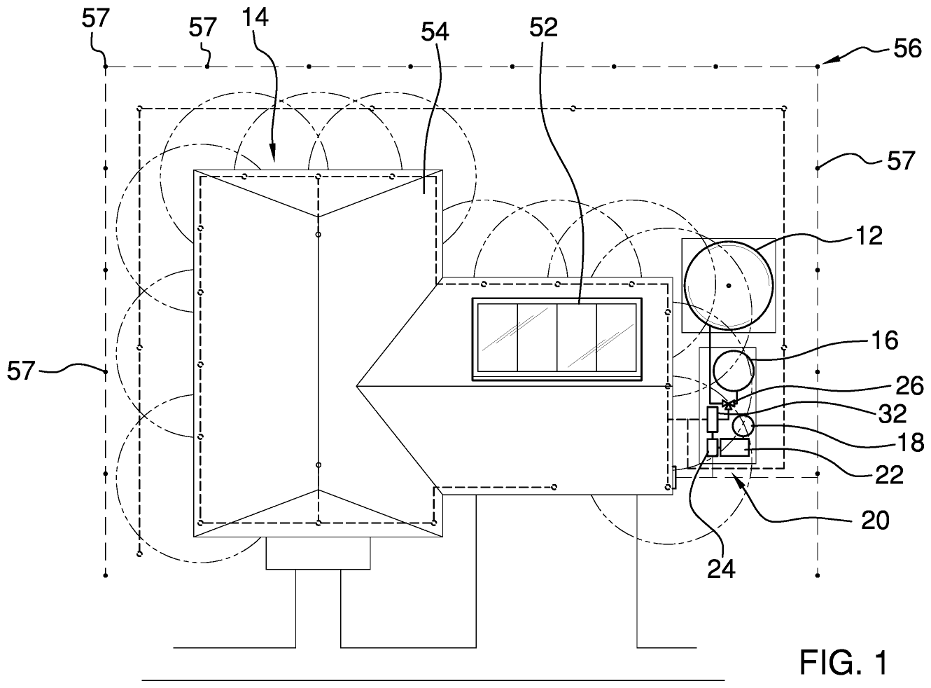

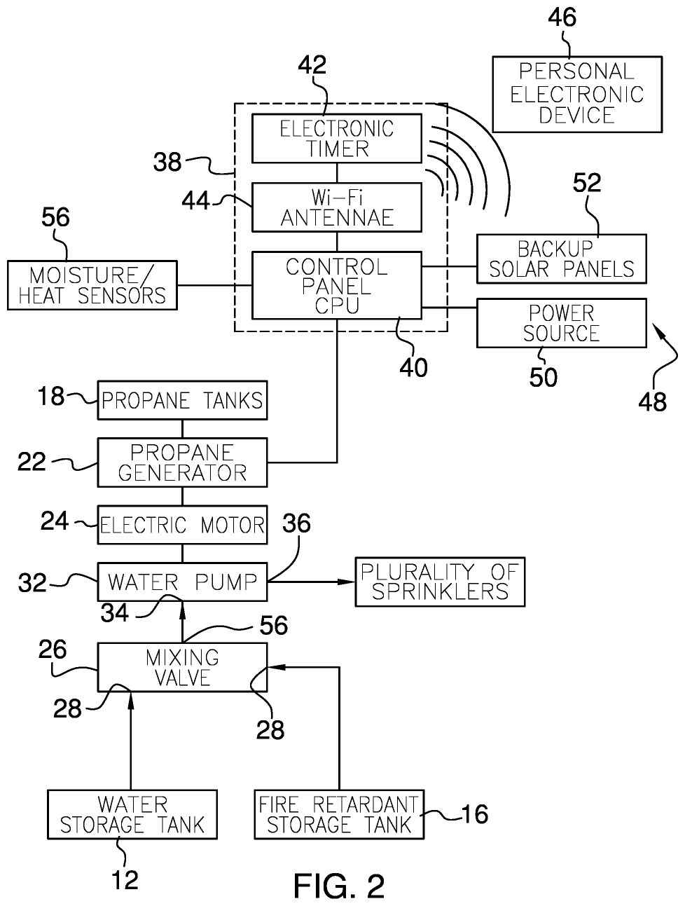

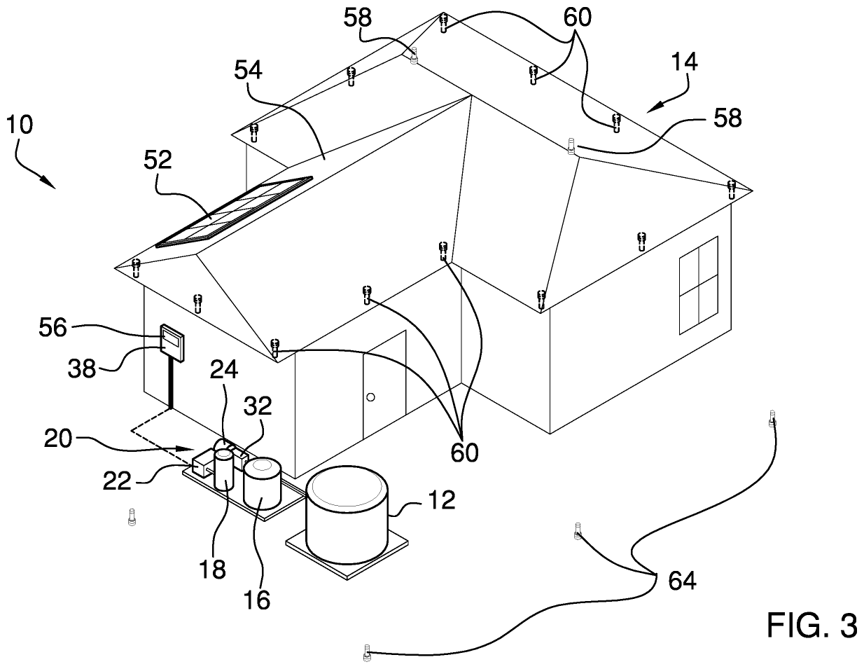

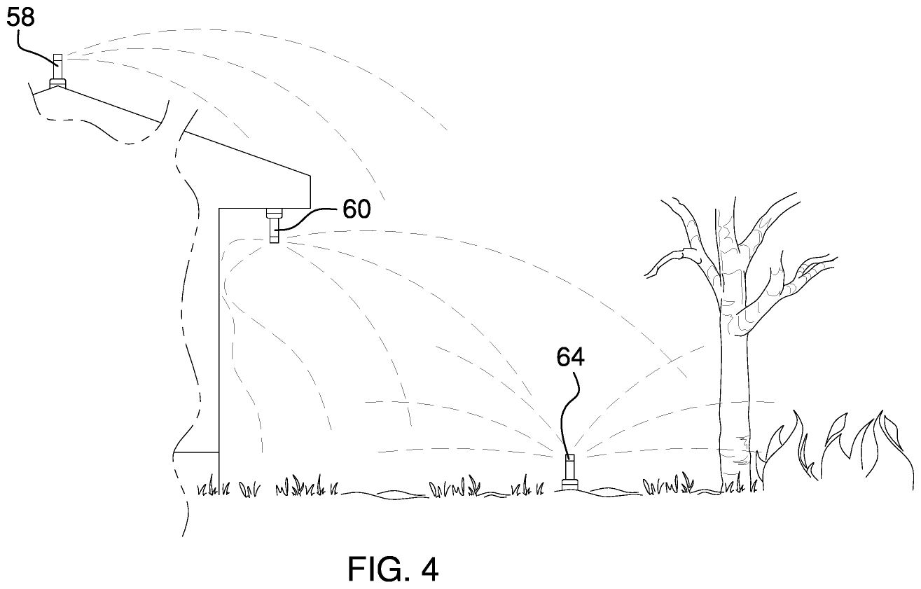

With reference now to the drawings, and in particular to FIGS. 1 through 4 thereof, a new fire suppression device embodying the principles and concepts of an embodiment of the disclosure and generally designated by the reference numeral 10 will be described.

As best illustrated in FIGS. 1 through 4, the remotely controlled fire suppression assembly 10 generally comprises a water reservoir 12 that contains water. The water reservoir 12 is positioned adjacent to a building 14, such as a house, a business or other type of occupancy. A fire retardant reservoir 16 is provided and the fire retardant reservoir 16 contains a fire retardant. Additionally, the fire retardant reservoir 16 is positioned adjacent to the building 14. The fire retardant may comprise a fire extinguishing gel or other viscous material that is capable of extinguishing fire. A propane tank 18 is provided that contains liquid propane and the propane tank 18 is positioned adjacent to the building 14.

A pumping unit 20 is positioned adjacent to the building 14 and the pumping unit 20 is in fluid communication with each of the water reservoir 12 and the fire retardant reservoir 16. In this way the pumping unit 20 can pump a mixture of the water and the fire retardant when the pumping unit 20 is turned on. The pumping unit 20 comprises a generator 22 that is in fluid communication with the propane tank 18 such that the generator 22 receives the liquid propane as fuel for running. Moreover, the generator 22 produces electrical current when the generator 22 is turned on. The generator 22 includes an internal combustion engine that runs on propane, rather than gasoline, to avoid the problems associated with long term storage of gasoline. The internal combustion engine may run on natural gas or any other combustible fuel other than gasoline.

The pumping unit 20 includes a motor 24 that is in electrical communication with the generator 22. The motor 24 turns in a first direction when the motor 24 is turned on. Additionally, the motor 24 may comprise an electric motor or the like. The pumping unit 20 includes a mixing valve 26 that has a pair of inputs 28 and an output 30. Each of the inputs 28 is fluidly coupled to a respective one of the water reservoir 12 and the fire retardant reservoir 16. In this way the mixing valve 26 receives the water and the fire retardant. The mixing valve 26 may comprise an electrically controlled fluid valve or the like.

The pumping unit 20 includes a pump 32 that has an intake 34 and an exhaust 36, and the intake 34 is fluidly coupled to the output 30 of the mixing valve 26. The pump 32 is mechanically coupled to the motor 24 such that the motor 24 rotates the pump 32 when the motor 24 is turned on. In this way the pump 32 is able to pump a mixture of the water and the fire retardant outwardly through the exhaust 36. The pump 32 may be an electric fluid pump or the like that has an output volume capable of servicing a fire extinguishing system.

A control panel 38 is mounted to the building 14 such that the control panel 38 is accessible to a user. The control panel 38 is in electrical communication with the pumping unit 20 for turning the pumping unit 20 on and off. The control panel 38 includes a control circuit 40 that is positioned in the control panel 38. The control circuit 40 is electrically coupled to the motor 24 and the control circuit 40 receives an activate input. Each of the generator 22 and the motor 24 is turned on when the control circuit 40 receives the activate input.

The control panel 38 includes an electronic timer 42 and the electronic timer 42 is electrically coupled to the control circuit 40. The electronic timer 42 counts down a pre-determined duration of time when the control circuit 40 receives the activate input. The control circuit 40 turns the motor 24 off when the electronic timer 42 counts down the pre-determined duration of time. The control panel 38 includes a transceiver 44 that is electrically coupled to the control circuit 40. The transceiver 44 is in wireless communication with a personal electronic 46 device to facilitate a user to remotely control the pumping unit 20. Additionally, the transceiver 44 may comprise a radio frequency transceiver or the like and the personal electronic device 46 may comprise a smart phone or other similar device. The transceiver 44 may employ a WPAN signal and the transceiver may be in wireless communication with an extrinsic communication network, such as the internet or a cellular phone network. In this way the transceiver 44 can communicate with the personal electronic device 46 over a great distance.

A power supply 48 is electrically coupled to the control panel 38 and the power supply 48 comprises at least one battery 50 that is positioned adjacent to the building 14. The at least one battery 50 is electrically coupled to the control circuit 40. The power supply 48 includes a solar panel 52 that is positioned on a roof 54 of the building 14 such that the solar panel 52 is exposed to sunlight. The solar panel 52 is electrically coupled to the at least one battery 50 for charging the at least one battery 50.

A fire sensor 56 is provided, the fire sensor 56 is coupled to the building 14 and the fire sensor 56 senses heat and moisture. The fire sensor 56 is in electrical communication with the control panel 38 and the pumping unit 20 is turned on when the fire sensor 56 senses heat and moisture that correspond to conditions of an active fire. The fire sensor 56 is electrically coupled to the control circuit 40 and the control circuit 40 receives the activate input when the fire sensor 56 senses heat and moisture that correspond to conditions of an active fire. The fire sensor 56 might include an infra red heat sensor, an electronic moisture sensor or any other type of sensing circuitry for sensing an active fire. As is most clearly shown in FIG. 1, the fire sensor 56 might include a plurality of sensor pods 57 that are distributed around the area in which the building is positioned. In this way the sensor pods 27 can monitor the entire perimeter of the area in which the building in positioned.

A plurality of roof sprinklers 58 is provided and each of the roof sprinklers 58 is positioned on the roof of the building 14 at strategic locations. Each of the roof sprinklers 58 is in fluid communication with the pumping unit 20 to spray the mixture of water and fire retardant for extinguishing a fire. Each of the roof sprinklers 58 is in fluid communication with the exhaust 36 of the pump 32 in the pumping unit 20. Each of the roof sprinklers 58 may be automated sprinklers that rotate back and forth to spray over a wide area.

A plurality of eave sprinklers 60 is provided and each of the eave sprinklers 60 is positioned on the eave 62 of the building 14 at strategic locations. Each of the eave sprinklers 60 is in fluid communication with the pumping unit 20 to spray the mixture of water and fire retardant for extinguishing the fire. Each of the eave sprinklers 60 is in fluid communication with the exhaust 36 of the pump 32 in the pumping unit 20. Additionally, each of the eave sprinklers 60 may be automated sprinklers that rotate back and forth to spray over a wide area.

A plurality of ground sprinklers 64 is provided and each of the ground sprinklers 64 is positioned on the ground 66 at strategic locations around the building 14. Each of the ground sprinklers 64 is in fluid communication with the pumping unit 20 to spray the mixture of water and fire retardant for extinguishing the fire. Moreover, each of the ground sprinklers 64 is in fluid communication with the exhaust 36 of the pump 32 in the pumping unit 20. Each of the ground sprinklers 64 may be automated sprinklers that rotate back and forth to spray over a wide area. As is most clearly shown in FIG. 1, the roof sprinklers 58, the eave sprinklers 60 and the ground sprinklers 64 are arranged to facilitate the maximum efficiency and capacity for protecting the building 14 and the area surrounding the building 14 from fire. Additionally, a series of pipes may be fluidly coupled between the roof sprinklers 58, the eave sprinklers 60, the ground sprinklers 64 and the pump 32 for distributing the mixture of water and fire retardant.

In use, the control circuit 40 turns on the generator 22 and the motor 24 when the fire sensor 56 senses heat and moisture levels that correspond to an active fire. Thus, each of the roof sprinklers 58, the eave sprinklers 60 and the ground sprinklers 64 spray the mixture of water and fire retardant in a uniform distribution on and around the building 14. In this way the building 14 is protected from an incoming fire, such as a wildfire or the like, and the building 14 is protected from being consumed by a fire that starts inside the building 14. Additionally, the personal electronic device 46 can be employed to remotely turn on the generator 22 and the motor 24 at any time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A remotely controlled fire suppression assembly for suppressing a fire in or around a building, said assembly comprising:
a water reservoir being configured to contain water, said water reservoir being positioned adjacent to a building;
a fire retardant reservoir being configured to contain a fire retardant, said fire retardant reservoir being positioned adjacent to the building;
a propane tank being configured to contain liquid propane, said propane tank being positioned adjacent to the building;
a pumping unit being positioned adjacent to the building, said pumping unit being in fluid communication with each of said water reservoir and said fire retardant reservoir wherein said pumping unit is configured to pump a mixture of the water and the fire retardant when said pumping unit is turned on;
a control panel being mounted to the building wherein said control panel is configured to be accessible to a user, said control panel being in electrical communication with said pumping unit for turning said pumping unit on and off;
a fire sensor being coupled to the building, said fire sensor sensing heat and moisture, said fire sensor being in electrical communication with said control panel, said control panel turning on said pumping unit when said fire sensor senses heat and moisture that correspond to conditions of an active fire;
a plurality of roof sprinklers, each of said roof sprinklers being positioned on the roof of the building at strategic locations, each of said roof sprinklers being in fluid communication with said pumping unit wherein each of said roof sprinklers is configured to spray the mixture of water and fire retardant for extinguishing a fire;
a plurality of eave sprinklers, each of said eave sprinklers being positioned on the eave of the building at strategic locations, each of said eave sprinklers being in fluid communication with said pumping unit wherein each of said eave sprinklers is configured to spray the mixture of water and fire retardant for extinguishing the fire; and
a plurality of ground sprinklers, each of said ground sprinklers being positioned on the ground at strategic locations around the building, each of said ground sprinklers being in fluid communication with said pumping unit wherein each of said ground sprinklers is configured to spray the mixture of water and fire retardant for extinguishing the fire.

2. The assembly according to claim 1, wherein said pumping unit comprises a generator being in fluid communication with said propane tank wherein said generator is configured to receive the liquid propane as fuel for running, said generator producing electrical current when said generator is turned on.

3. The assembly according to claim 2, wherein said pumping unit comprises a motor being in electrical communication with said generator, said motor turning in a first direction when said motor is turned on.

4. The assembly according to claim 3, wherein said pumping unit includes a pump having an intake and an exhaust, said pump being mechanically coupled to said motor such that said motor rotates said pump when said motor is turned on.

5. The assembly according to claim 4, wherein said pumping unit includes a mixing valve having a pair of inputs and an output, each of said inputs being fluidly coupled to a respective one of said water tank and said fire retardant tank wherein said mixing valve is configured to receive the water and the fire retardant, said intake of said pump being fluidly coupled to said output of said mixing valve wherein said pump is configured to pump a mixture of the water and the fire retardant outwardly through said exhaust of said pump.

6. The assembly according to claim 3, wherein said control panel includes a control circuit being positioned in said control panel, said control circuit being electrically coupled to said motor, said control circuit receiving an activate input, said motor being turned on when said control circuit receives said activate input.

7. The assembly according to claim 6, wherein said control panel includes an electronic timer, said electronic timer being electrically coupled to said control circuit, said electronic timer counting down a pre-determined duration of time when said control circuit receives said activate input, said control circuit turning said motor off when said electronic timer counts down said pre-determined duration of time.

8. The assembly according to claim 6, wherein said control panel includes a transceiver being electrically coupled to said control circuit, said transceiver being in wireless communication with a personal electronic device wherein said transceiver is configure to facilitate a user to remotely control said pumping unit.

9. The assembly according to claim 4, wherein:
each of said roof sprinklers is in fluid communication with said exhaust of said pump in said pumping unit;
each of said eave sprinklers is in fluid communication with said exhaust of said pump in said pumping unit; and
each of said ground sprinklers is in fluid communication with said exhaust of said pump in said pumping unit.

10. A remotely controlled fire suppression assembly for suppressing a fire in or around a building, said assembly comprising:
a water reservoir being configured to contain water, said water reservoir being positioned adjacent to a building;
a fire retardant reservoir being configured to contain a fire retardant, said fire retardant reservoir being positioned adjacent to the building;
a propane tank being configured to contain liquid propane, said propane tank being positioned adjacent to the building;
a pumping unit being positioned adjacent to the building, said pumping unit being in fluid communication with each of said water reservoir and said fire retardant reservoir wherein said pumping unit is configured to pump a mixture of the water and the fire retardant when said pumping unit is turned on, said pumping unit comprising:
a generator being in fluid communication with said propane tank wherein said generator is configured to receive the liquid propane as fuel for running, said generator producing electrical current when said generator is turned on;
a motor being in electrical communication with said generator, said motor turning in a first direction when said motor is turned on;
a mixing valve having a pair of inputs and an output, each of said inputs being fluidly coupled to a respective one of said water tank and said fire retardant tank wherein said mixing valve is configured to receive the water and the fire retardant; and
a pump having an intake and an exhaust, said intake being fluidly coupled to said output of said mixing valve, said pump being mechanically coupled to said motor such that said motor rotates said pump when said motor is turned on wherein said pump is configured to pump a mixture of the water and the fire retardant outwardly through said exhaust;
a control panel being mounted to the building wherein said control panel is configured to be accessible to a user, said control panel being in electrical communication with said pumping unit for turning said pumping unit on and off, said control panel including:
a control circuit being positioned in said control panel, said control circuit being electrically coupled to said motor, said control circuit receiving an activate input, said motor being turned on when said control circuit receives said activate input;
an electronic timer, said electronic timer being electrically coupled to said control circuit, said electronic timer counting down a pre-determined duration of time when said control circuit receives said activate input, said control circuit turning said motor off when said electronic timer counts down said pre-determined duration of time; and
a transceiver being electrically coupled to said control circuit, said transceiver being in wireless communication with a personal electronic device wherein said transceiver is configure to facilitate a user to remotely control said pumping unit;
a power supply being electrically coupled to said control panel, said power supply comprising:
at least one battery being positioned adjacent to the building, said at least one battery being electrically coupled to said control circuit; and
a solar panel being positioned on a roof of the building wherein said solar panel is configured to be exposed to sunlight, said solar panel being electrically coupled to said at least one battery for charging said at least one battery;
a fire sensor being coupled to the building, said fire sensor sensing heat and moisture, said fire sensor being in electrical communication with said control panel, said control panel turning on said pumping unit when said fire sensor senses heat and moisture that correspond to conditions of an active fire, said fire sensor being electrically coupled to said control circuit, said control circuit receiving said activate input when said fire sensor senses heat and moisture that correspond to conditions of an active fire;
a plurality of roof sprinklers, each of said roof sprinklers being positioned on the roof of the building at strategic locations, each of said roof sprinklers being in fluid communication with said pumping unit wherein each of said roof sprinklers is configured to spray the mixture of water and fire retardant for extinguishing a fire, each of said roof sprinklers being in fluid communication with said exhaust of said pump in said pumping unit;
a plurality of eave sprinklers, each of said eave sprinklers being positioned on the eave of the building at strategic locations, each of said eave sprinklers being in fluid communication with said pumping unit wherein each of said eave sprinklers is configured to spray the mixture of water and fire retardant for extinguishing the fire, each of said eave sprinklers being in fluid communication with said exhaust of said pump in said pumping unit; and
a plurality of ground sprinklers, each of said ground sprinklers being positioned on the ground at strategic locations around the building, each of said ground sprinklers being in fluid communication with said pumping unit wherein each of said ground sprinklers is configured to spray the mixture of water and fire retardant for extinguishing the fire, each of said ground sprinklers being in fluid communication with said exhaust of said pump in said pumping unit.
